(19) United States
(12) Patent Application Publication
(10) Pub. No.: US 2022/0321403 A1
(43) Pub. Date: Oct. 6, 2022

(54) PROGRAMMABLE NETWORK SEGMENTATION FOR MULTI-TENANT FPGAS IN CLOUD INFRASTRUCTURES

(71) Applicant: Nokia Solutions and Networks Oy, Espoo (FI)

(72) Inventors: Andrea ENRICI, Bourg la Reine (FR); Bogdan USCUMLIC, Les Ulis (FR)

(73) Assignee: Nokia Solutions and Networks Oy, Espoo (FI)

(21) Appl. No.: 17/221,057

(22) Filed: Apr. 2, 2021

(51) Int. Cl. H04L 12/24; H04L 29/08

(52) U.S. Cl. CPC H04L 41/082; H04L 41/0896; H04L 41/0816; H04L 41/12; H04L 67/10

(57) ABSTRACT

A network device for managing network segmentation in a network infrastructure includes at least one processor, and at least one memory including computer program code, the at least one memory and the computer program code configured to, with the at least one processor, cause the network device to receive a request to execute a distributed workload, the request including distributed workload information, compute a network configuration for the network infrastructure based on the distributed workload information and a current status of the network infrastructure, and configure a plurality of reconfigurable resources of a programmable device to execute the distributed workload based on the network configuration.

### BACKGROUND

A field-programmable gate array (FPGA) is an integrated circuit designed to be configured or re-configured after manufacture. FPGAs contain an array of Configurable Logic Blocks (CLBs), and a hierarchy of reconfigurable interconnects that allow these blocks to be wired together, like many logic gates that can be inter-wired in different configurations. CLBs may be configured to perform complex combinational functions, or simple logic gates like AND and XOR. CLBs also include memory blocks, which may be simple flip-flops or more complete blocks of memory, and specialized Digital Signal Processing blocks (DSPs) configured to execute some common operations (e.g., filters).

### SUMMARY

The scope of protection sought for various example embodiments of the disclosure is set out by the independent claims. The example embodiments and/or features, if any, described in this specification that do not fall under the scope of the independent claims are to be interpreted as examples useful for understanding various embodiments.

One or more example embodiments provide a field-programmable gate array (FPGA) architecture that may enable reduced latency and/or increased security of a set of distributed multi-tenant workloads that execute on different FPGA nodes.

At least one example embodiment provides a network device for managing network segmentation in a network infrastructure. The network device may include at least one processor, at least one memory including computer program code, the at least one memory and the computer program code configured to, with the at least one processor, cause the network device to receive a request to execute a distributed workload. The request may include distributed workload information. The at least one memory and the computer program code may be further configured to, with the at least one processor, cause the network device to compute a network configuration for the network infrastructure based on the distributed workload information and a current status of the network infrastructure. The at least one memory and the computer program code may be further configured to, with the at least one processor, cause the network device to configure a plurality of reconfigurable resources of a programmable device to execute the distributed workload based on the network configuration.

The network configuration may include a network segmentation configuration and an ad-hoc network configuration for the network infrastructure The at least one memory and the computer program code may be further configured to, with the at least one processor, cause the network device to compute the network configuration by computing the network segmentation configuration based on the distributed workload information and the current status of the network infrastructure, and computing the ad-hoc network configuration based on the network segmentation configuration.

The at least one memory and the computer program code may be further configured to, with the at least one processor, cause the network device to compute the ad-hoc network configuration by allocating the plurality of reconfigurable resources according to a respective bandwidth capacity of a reconfigurable resource of the plurality of reconfigurable resources, and a respective computed bandwidth of the reconfigurable resource.

The at least one memory and the computer program code may be further configured to, with the at least one processor, cause the network device to compute the ad-hoc network configuration by defining reconfigurable partitions of the reconfigurable resources and/or defining a static logic of the reconfigurable resources.

The at least one memory and the computer program code may be further configured to, with the at least one processor, cause the network device to compute the network segmentation configuration based on the distributed workload information, the current status of the network infrastructure, topological and functional properties of the plurality of reconfigurable resources and a given reconfiguration time.

The at least one memory and the computer program code may be further configured to, with the at least one processor, cause the network device to determine the current status of the network infrastructure based on physical properties of the network infrastructure.

The workload information may include an objective function. The at least one memory and the computer program code may be further configured to, with the at least one processor, cause the network device to compute the network configuration based on the objective function.

The network device may further include a memory storing a library of allocation algorithms. The at least one memory and the computer program code may be further configured to, with the at least one processor, cause the network device to determine an allocation algorithm, from the library of allocation algorithms, based on the request, and compute the network segmentation configuration based on the distributed workload information and the current status of the network infrastructure according to the allocation algorithm. The allocation algorithm may be a polynomial time complexity algorithm.

The network device may further include a memory storing a library of programming protocol-independent processor (P4) switches. The at least one memory and the computer program code may be further configured to, with the at least one processor, cause the network device to configure the plurality of reconfigurable resources based on P4 switches in the library of P4 switches.

At least one example embodiment provides a method for managing network segmentation of a network infrastructure. The method may include receiving a request to execute a distributed workload from a network orchestrator. The request may include distributed workload information. The method may further include computing a network configuration for the network infrastructure based on the distributed workload information and a current status of a network infrastructure. The method may further include configuring a plurality of reconfigurable resources of a programmable device to execute the distributed workload based on the network configuration.

At least one example embodiment provides a network device for managing network segmentation in a network infrastructure. The network device may a means for for receiving a request to execute a distributed workload. The request may include distributed workload information. The network device may further include a means for computing a network configuration for the network infrastructure based on the distributed workload information and a current status of the network infrastructure. The network device may further include a means for configuring a plurality of reconfigurable resources of a programmable device to execute the distributed workload based on the network configuration.

At least one example embodiment provides a non-transitory computer-readable storage medium storing computer-readable instructions that, when executed, cause processing circuitry to perform a method for managing network segmentation in a cloud infrastructure. The method may include receiving a request to execute a distributed workload from a network orchestrator. The request may include distributed workload information. The method may further include computing a network configuration for the network infrastructure based on the distributed workload information and a current status of a network infrastructure. The method may further include configuring a plurality of reconfigurable resources of a programmable device to execute the distributed workload based on the network configuration.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating a field programmable gate array (FPGA) architecture for explaining example embodiments.

FIG. 2 is a block diagram illustrating a logical configuration of a FPGA network architecture according to example embodiments.

FIG. 3 is a block diagram illustrating a logical configuration of a FPGA network segmentation manager according to example embodiments.

FIG. 4 is a flow chart illustrating a method according to example embodiments.

FIG. 5 illustrates an example of an overview of a network segmented into sub-networks governed by programmable P4 switches, according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

In modern cloud-based data centers, servers are equipped with reconfigurable hardware (e.g., field-programmable gate arrays (FPGAs)), which is used to accelerate the computation of data-intensive or time-sensitive applications. The FPGAs may be interconnected in a free topology (e.g., a connected bidirectional graph of any type). The interconnected FPGAs may be referred to as a network of FPGAs.

FPGA reconfigurability is referred to as “partial reconfiguration,” which supposes that parts of FPGA hardware may be reconfigured while the FPGA is running. The partial reconfiguration is performed on allocated portions of a FPGA chip (or FPGA reconfigurable logic), which are known as “partial reconfiguration slots.”

Network segmentation is an architectural approach that divides a network into multiple segments (network segments) or subnets, each acting as its own network. This allows network administrators to control the flow of traffic between subnets based on granular policies. Organizations may use segmentation to improve monitoring, boost performance, localize technical issues, enhance security, etc. A network segment may be either a subset of the FPGAs of a network of FPGAs, or a subset of reconfigurable (partial reconfiguration) slots of the FPGAs of a network of FPGAs.

Example embodiments use network segmentation to create intelligent groupings of FPGA workloads based on characteristics of workloads communicating inside a data center. Thus, example embodiments may leverage network segmentation to moderate lateral traffic between servers equipped with FPGAs in the same segment, moderate intra-segment traffic so that a server with a first FPGA (FPGA A) can talk to a server with a second FPGA (FPGA B), if the identity of the requesting resources matches the permission configured for that server/application/host/user. Since policies and permissions for this type of segmentation are based on resource identity, the approach is independent from the physical network infrastructure. Example embodiments use network segmentation to improve bandwidth use between network segments in a network of FPGAs.

Programming Protocol-independent Processors (P4) is a novel data-plane programming language enabling data-plane programming during the exploitation life-time of a device. P4 provides a novel paradigm, which differs from the approach used by traditional Application Specific Integrated Circuit (ASIC)-based devices (e.g., switches). Furthermore, P4 is target-independent in that the programming language may be applied to central processing units (CPUs), FPGAs, system-on-chips (SoCs), etc., and is protocol-independent in that the programming language supports all data-plane protocols and may be used to develop new protocols.

When implemented on FPGAs, P4 applications allow for reprogramming of only some portions of a FPGA (a portion of the partial reconfiguration slots), without stopping (or interrupting) operation of the device.

P4 based implementations allow for implementation of a wide variety of data forwarding/switching protocols and technologies. Furthermore, P4 allows to implement these functions on the reconfigurable accelerators, like FPGAs.

Although discussed herein with regard to P4 modules and workloads, example embodiments should not be limited to this example. Rather, example embodiments may be applicable to any kind of workload.

One or more example embodiments provide programmable hardware (e.g., FPGA) architectures and/or methods enabling programmable hardware reconfiguration (and/or installation of new programming modules) in multi-tenant workloads with reduced latency and/or improved security. As discussed in more detail below, the programmable hardware (e.g., FPGA) architecture may include a plurality of reconfigurable resources (e.g., partial reconfiguration slots), a network segmentation manager, and a library of algorithms (bitstreams). The library of algorithms may be installed on the off-chip memory of the programmable hardware.

For example purposes, example embodiments will be described with regard to FPGAs. However, example embodiments should not be limited to this example.

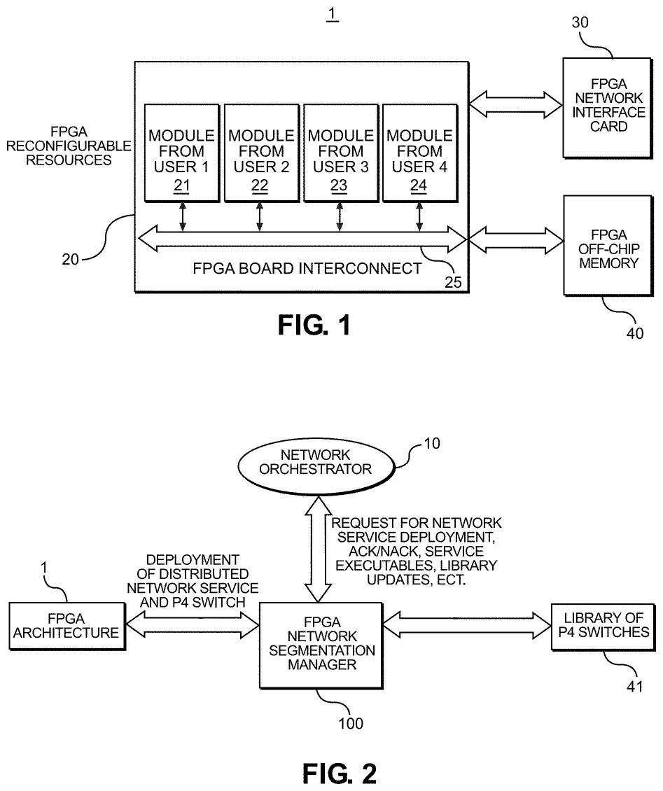

FIG. 1 is a block diagram illustrating a FPGA architecture 1 for explaining example embodiments.

Referring to FIG. 1, the FPGA architecture 1 includes a FPGA 20, FPGA network interface card 30, and FPGA off-chip memory 40. The FPGA 20 includes a plurality of partial reconfiguration slots 21-24, and a FPGA bus 25. As mentioned similarly above, the library of algorithms may be installed on the FPGA off-chip memory 40. The FPGA off-chip memory 40 may be a computer readable storage medium that may include a random access memory (RAM), read only memory (ROM), and/or a permanent mass storage device, such as a disk or flash drive.

Each of the partial reconfiguration slots 21-24 includes a set of reconfigurable resources (e.g., Digital Signal Processors (DSPs), memory blocks, logic blocks, etc.) and may be allocated to a module for use by a respective user. The amount of resources per slot may vary. For example purposes, P4 modules for users 1-4 are shown in FIG. 1. However, example embodiments should not be limited to these examples. The partial reconfiguration slots 21-24 are interconnected by the FPGA interconnect 25. The plurality of partial reconfiguration slots may also be referred to as a plurality of reconfigurable resources.

The modules on the partial reconfiguration slots 21-24 may send and receive data via the FPGA network interface card 30. The FPGA network interface card 30 may connect the reconfigurable slots 21-24 to an Ethernet or peripheral component internet express (PCIe) interface (not shown) for receiving partial reconfiguration instructions. However, the example embodiments are not limited thereto. In another example embodiment, the partial reconfiguration slots 21-24 may receive partial reconfiguration instructions via a Joint Test Action Group (JTAG) or universal serial bus (USB) port (not shown), in which case the FPGA network interface card 30 may be omitted. In still another example embodiment, the partial reconfiguration instructions may be stored in the FPGA off-chip memory 40 and the FPGA network interface card 30 may be omitted.

FIG. 2 is a block diagram illustrating a logical configuration of a FPGA network architecture according to example embodiments.

Referring to FIG. 2, the FPGA network architecture includes a FPGA network segmentation manager (FNSM) 100 configured to physically deploy distributed services, requested by a network orchestrator 10, with proper network segmentation. The FNSM 100 selects and implements a specific P4 switch selected from among a library of P4 switches 41. The library of P4 switches 41 may be stored in the FPGA off-chip memory 40. Alternatively, the library of P4 switches 41 may be stored in an on-chip RAM of the FPGA (not shown).

The library of P4 switches 41 may include a library of P4 programs. Each P4 program of the library of P4 programs implements a P4 switch with a defined (or, alternately, given) data forwarding/switching protocol and/or the P4 program implements a configuration (or flavor) of a given protocol (e.g., Spanning Tree protocol). The library of P4 switches 41 may include, for example, a set of wireless network (e.g. 5th generation wireless network) functions and related functions (e.g., various user plan functions (UPF), such as intermediate UPFs, protocol data unit (PDU) session anchor (PSA) UPFs, load-balancers, packet filtering functions, etc.).

The FNSM 100 deploys the distributed services according to the selected P4 switch to the FPGA 20 via the FPGA network interface card 30. The FNSM 100 will be discussed in more detail below.

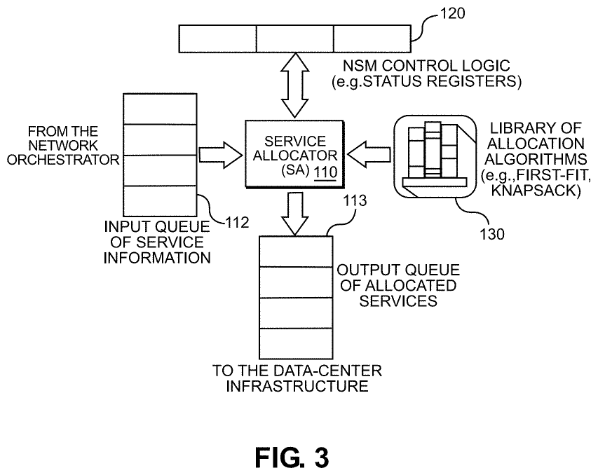

FIG. 3 is a block diagram illustrating a logical configuration of the FNSM 100 according to example embodiments.

Referring to FIG. 3, the FNSM 100 comprises control logic 110 configured to implement a service allocator (SA). The control logic 110 may be one or more processors. More generally, the control logic 110 may include processing circuitry such as hardware including logic circuits, or a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processor may be configured to carry out instructions of a computer program by performing the arithmetical, logical, and input/output operations of the system. As discussed herein, the control logic 110 may also be referred to as service allocator (SA) 110.

The SA 110 may compute the allocation of an input service (e.g., where to allocate functions within a service, how to partition the FPGA 20, etc.) and a configuration of corresponding subnetworks (e.g., subnet masks, IP addresses, etc.).

The FNSM 100 may further include network segmentation manager (NSM) control logic 120, an input queue 112 including service information received from the network orchestrator 10, an output queue 113 including allocated services calculated by the SA 110 to be deployed by the FNSM 100, and a library of allocation algorithms 130.

The NSM control logic 120 may include, for example, status registers indicating a current status of the network infrastructure, distributed workload information, a current status of the SA 110, etc.

The library of allocation algorithms 130 may be included in the library of P4 switches 41. Alternatively, the library of allocation algorithms may be stored separately from the library of P4 switches 41. The library of allocation algorithms 130 may be stored in the FPGA off-chip memory 40, and/or the on-chip RAM of the FPGA. The library of allocation algorithms 130 may include, for example, algorithms such as “first-fit,” “knapsack,” and/or other algorithms that consider the characteristics (or particularities) of a network to which the services are allocated. The library of allocation algorithms 130 may include, for example, polynomial time complexity algorithms.

Example functionality of the FNSM 100 and the SA 110 will be discussed in more detail below.

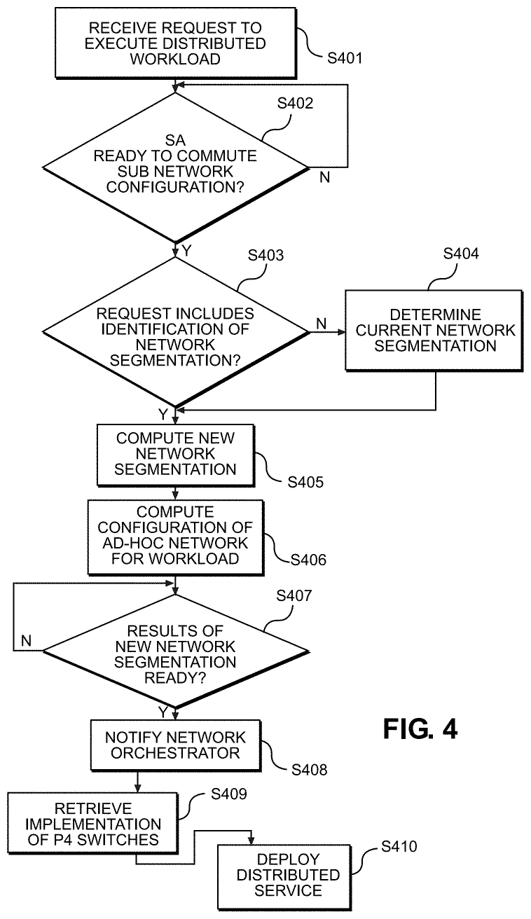

FIG. 4 is a flow chart illustrating a method for segmentation of multi-tenant FPGAs in a cloud infrastructure, according to example embodiments. The method shown in FIG. 4 may be executed by the FPGA network architecture shown and described with regard to FIGS. 1-3, and will be discussed in this manner for example purposes. However, example embodiments should not be limited to only this example. Moreover, the example embodiment shown in FIG. 4 will be described with regard to operations performed by elements/components of the FPGA network architecture shown and described with regard to FIGS. 1-3. However, it should be understood that example embodiments may be described, in at least some instances, similarly with regard to the operations being performed by at least one processor in conjunction with at least one memory and computer program code stored in the at least one memory, wherein the at least one memory and the computer program code are configured to, with the at least one processor, cause the element(s) of the FPGA network architecture to perform the respective operations.

Referring to FIG. 4, at step S401, the FNSM 100 receives a request to execute a distributed workload from the network orchestrator 10. A distributed workload is a set of functions executed by at least some FPGAs in a network. The request from the network orchestrator 10 may include distributed workload information including the workload's executables, meta-data specifying characteristics of the executables (e.g., distributed services), a current status of the network infrastructure, an indication to compute either a full or a partial reconfiguration of the FPGA network, and/or an objective function.

The workload's executables may be a set of bitstreams for reprogramming at least some of the FPGAs in the network to achieve the distributed workload. The objective function may include one or more functions for minimizing a number of FPGAs used, minimizing the total energy consumption of used FPGAs, minimizing the link bandwidth used, improving the total bandwidth usage between network segments on a given FPGA, improving the total bandwidth usage between network segments in the FPGA network, etc.

The current status of the network infrastructure may include information (e.g., an annotated graph, a look-up table, etc.) about a current status of the network infrastructure (e.g., the current allocation of functions onto FPGAs, network addresses of FPGAs, network segmentation, etc.). The current status of the network infrastructure may indicate a current network segmentation. A network segmentation may include a plurality of network segments.

According to one or more example embodiments, a network segment may be: 1) a subset of a set of reconfigurable FPGA slots (SFᵢ) of the set of FPGAs (Fᵢ) interconnected in a free topology (e.g., subset of reconfigurable slots within a FPGA); or 2) a subset of Fᵢ (e.g., within a network of FPGAs). A subset of SFᵢ, for some Fᵢ, may be referred to as a network segment (NSFᵢ), and a subset of Fᵢ is referred to as NFᵢ.

In response to receiving the request from the network orchestrator 10, at step S402 the FNSM 100 reads the status of a status register of the SA 110 to determine whether the SA 110 is ready to compute the subnetwork configuration of a new workload. The status register of the SA 110 may be included in the NSM logic 120. If the SA 110 is not ready to compute the subnetwork configuration of a new workload, the FNSM 100 polls the status register of the SA 110 until the SA 110 is ready (e.g., the SA 110 is not executing a previous computation task) to compute the subnetwork configuration of a new workload.

Returning to step S402, if the FNSM 100 determines that the SA 110 is ready to compute the subnetwork configuration of a new workload, then at step S403 the SA 110 determines whether the request from the network orchestrator includes the information about the current status of the network.

If the request from the network orchestrator 10 does not include the information about the current status of the network, then at step SS the SA 110 determines the current network segmentation of the network. The SA 110 may determine the current segmentation of the network based on characteristics or particularities (e.g., physical properties) of the network and/or network equipment.

For example, the SA 110 may determine the current segmentation based on a type of FPGA card used. In this case, the number of network segments may depend on the number of types of FPGA cards that are used. In some other example embodiments the SA 110 may use some other characteristics or particularities to determine the current network segmentation. For example, security based network segmentation (some parts of network need to be isolated for security reasons), power consumption based network segmentation, multicast group based network segmentation, etc.

At step S405, the SA 110 computes a new network segmentation of the network infrastructure to determine network segments and/or to improve bandwidth use between the segments according to the request from the network orchestrator 10.

The SA 110 may compute the new (or updated) network segmentation of the network infrastructure according to the request. The SA 110 may compute the new (or updated) network segmentation of the network infrastructure based on the topological and functional properties of the interconnected P4 switches (e.g., a P4 load-balancer that is located at a “core level” of a data center might have different network segmentation requirements than a P4 switch implementing a 5G core function that is allocated at an FPGA that is positioned at an “access level” in the data center), and a required reconfiguration time of the network (as specified by the network orchestrator 10).

The SA 110 may select an algorithm for computing the new network segmentation of the network infrastructure based on the objective function, or the request from the network orchestrator 10 may include instructions for selecting the algorithm from among the library of algorithms 130. The selected algorithm may be a polynomial time complexity algorithm.

For example, the objective function included in the request to execute the distributed workload may include a function for at least one of minimizing a number of FPGAs used, minimizing the total energy consumption of used FPGAs, minimizing the link bandwidth used, etc. The SA 110 may compute the network segmentation of the network infrastructure based on the objective function.

The SA 110 may optimize bandwidth use in the FPGA network by computing network segments and routing between the network segments in the FPGA network according to the selected algorithm. The SA 110 may compute a partial reconfiguration of the FPGA network (e.g., including no changes to the internal reconfiguration structures of the FPGAs in the network) according to the selected algorithm, or the SA 110 may compute a full reconfiguration of the FPGA network (e.g., including changes to the internal reconfiguration structures of the FPGAs in the network). According to one or more example embodiments, the request from the network orchestrator 10 may indicate whether the SA 110 is to compute a full or partial reconfiguration of the FPGA network.

Below is example pseudocode of a greedy algorithm for computing a network segmentation of the network infrastructure for improving the total bandwidth usage between network segments on a given FPGA (e.g., a full FPGA reconfiguration):

Input parameters:
Set of network segments NSFᵢ.
Set L of network links l.
Let be K the set of n-shortest routing paths k_{i,j} between any pair NSFᵢ, NSFⱼ on FPGA Fᵢ.
Let B be the set of bandwidth requirement b_{i,j} for data communication between any pair NSFᵢ, NSFⱼ on FPGA Fᵢ
Let Cₗ be the bandwidth occupancy of all traffic routed on link l
Let Cₘₐₓ be the total allowed bandwidth on any link

Pseudocode:

```
FOR all (i,j)
Sort set K in order of increasing path length. The obtained
vector of sorted k_{i,j} is K_sort[p].
Sort set B in order of decreasing bandwidth demands. The
obtained vector of sorted b_{i,j} is B_sort[q].
END FOR
q = −1, Cₗ = 0
WHILE q ≤ n − 1 (bandwidth demand selection from smaller to
higher index value, that is from highest bandwidth demand to
lowest)
q = q + 1
p = −1
WHILE p ≤ n − 1 (routing path selection from smaller to
higher index value, that is from shortest to longest path)
p = p + 1
can_be_routed = FALSE
FOR all l ∈ L, such that l ∈ K_sort[p]
    IF B_{sort[q]} + Cₗ ≤ Cₘₐₓ THEN
          can_be_routed = TRUE
          chosen_path = p
      END IF
  END FOR
  IF can_be_routed = FALSE THEN
      BREAK
    ELSE
Route demand q on path chosen_path;
  FOR all l ∈ L, such that l ∈ K_sort[chosen_path]
          Cₗ = Cₗ + B_{sort[q]}
      END FOR
        BREAK
  END IF
END WHILE
END WHILE
```

The above algorithm for computing a network segmentation of the network infrastructure may be used for computing a network segmentation of the network infrastructure (e.g., a partial reconfiguration) by changing the inputs as follows:

Input parameters:
Set of network segments NFᵢ.
Set L of network links l.
Let be K the set of n-shortest routing paths k_{i,j} between any pair NFᵢ, NFⱼ in FPGA network.
Let B be the set of bandwidth requirement b_{i,j} for data communication between any pair NFᵢ, NFⱼ in FPGA network.
Let Cₗ be the bandwidth occupancy of all traffic routed on link l.
Let Cₘₐₓ be the total allowed bandwidth on any link.

At step S406, the SA 110 computes a configuration of an ad-hoc network for the requested workload (e.g., subnetwork addresses, reference to P4 switch implementation, etc.) based on the computed network segmentation.

If the network segmentation computed in step S405 is a partial reconfiguration of the FPGA network, the SA 110 may allocate reconfigurable resources 21-24 on each FPGA according to a bandwidth capacity of the FPGA and a required bandwidth of the FPGA. The required bandwidth of each FPGA is known from the computed network segmentation of step S405. Because the FPGAs include the reconfigurable resources 21-24 the available bandwidth per reconfigurable resource slot 21-24 is also fixed (or, alternatively, defined or given). The partial reconfiguration of the FPGA network is a relatively fast implementation of the network segmentation.

If the network segmentation computed in step S405 is a full reconfiguration of the FPGA network, the SA 110 may fully partition each, or at least one of, the FPGAs of the FPGA network. For example, the SA 110 may redefine all, or some, of the reconfigurable resources 21-24 of the FPGAs and/or redefine all, or some, of the static logic of the FPGAs. The full reconfiguration of the FPGA network allows the SA 110 to fully optimize the FPGA bandwidth (interconnects) to satisfy the network segmentation computed in step S405. The full reconfiguration is a relatively slower implementation of the network segmentation.

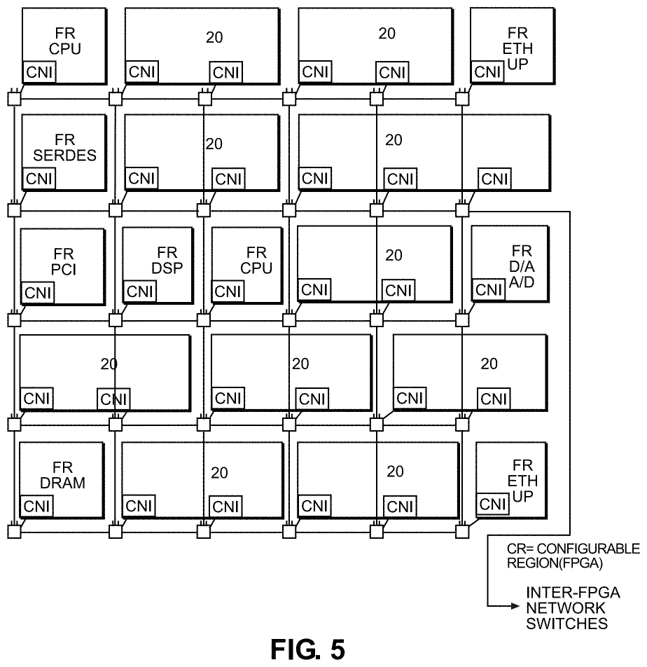

FIG. 5 illustrates an example of an overview of a network segmented into sub-networks governed by programmable P4 switches, according to example embodiments.

Referring to FIG. 5, for the purpose of illustration, suppose that a polynomial algorithm for network segmentation is required for the distribution of the FPGAs 20, where each FPGA 20 contains a number of P4 switches.

For simplicity, it is assumed that each FPGA 20 element has a single P4 switch. However, example embodiments are not restricted thereto and each FPGA 20 may have more than one P4 switch. Further, for purpose of explanation, it is assumed that a minimum number of P4 switches in a “network segment” shall be greater or equal to two P4 switches, and that a network segment is composed of the neighboring switches (e.g., to support a pair of P4 switches which perform some complementary function). However, example embodiments are not limited thereto.

In this case, as can be appreciated, if the FPGAs 20 are enumerated, a network segmentation solution may be calculated according to an algorithm that may run in polynomial time.

Returning to FIG. 4, at step S407, while the SA 110 computes the configuration of an ad-hoc network for the new workload, the FNSM 100 polls the status register of the SA 110. If the results of the network segmentation are not ready at the SA 110, then the FNSM 100 returns to step S407 and continues to poll the status register of the SA 110 until the results of the network segmentation are ready at the SA 110.

Returning to step S407, if the FNSM 100 determines that the results of the network segmentation are ready at the SA 110, then at step S408 the FNSM 100 notifies the network orchestrator 10 that the service is about to be deployed. The FNSM 100 may notify the network orchestrator 10 that the service is about to be deployed via one or more control plane messages.

At step S409, the FNSM 100 retrieves the implementation of the P4 switch as computed by the SA 110 from the library 41. The SA 110 may compute (e.g., at step S406) different implementations of a same function for different FPGA chips included in an ad-hoc network such that a respective function may be adapted to a specific FPGA chip. Therefore, in step S409, the FNSM 100 retrieves the particular P4 implementations corresponding to the computed set of FPGAs.

At step S410, the FNSM 100 physically deploys the distributed service and the P4 switches for network segmentation to the FPGA 20. For example, the FNSM 100 transmits instructions to the FPGAs 20 to reconfigure at least some of their associated reconfigurable resources 21-24. The FPGA 20 then executes the instructions to physically reallocate FPGA resources in the at least some reconfigurable resources 21-24. Some of the reconfigurable resources 21-24 may be running some previously allocated function when the FPGA 20 receives the instructions from the FNSM 100. In this case, the reconfigurable resources 21-24 running the previously allocated function may be reallocated according to the instructions.

Returning to step S403, if the request from the network orchestrator 10 includes the information about the current status of the network, the process proceeds to step S405 and continues as discussed above.

For the sake of simplicity, example embodiments are discussed with regard to the SA 110 computing configuration of one ad-hoc network at a time. However, example embodiments should not be limited to this example. Rather, the SA 110 may compute any number of configurations concurrently or simultaneously.

In case the library of allocation algorithms 130 resides locally on an FPGA RAM memory, a communication mechanism may be provided between the network orchestrator 10 and the FNSM 100 to update the library of allocation algorithms 130 (e.g., to store new algorithms and/or delete old algorithms) as needed.

According to one or more example embodiments, a FPGA may include a plurality of reconfigurable interconnect resources (e.g., wires, switches, buses, etc.). These interconnect resources are reconfigurable resources for transferring information, as opposed to the resources for processing information (e.g., slots of the FPGA).

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network apparatuses, elements or entities including cloud-based data centers, computers, cloud-based servers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network apparatus, network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network apparatuses, elements or entities including cloud-based data centers, computers, cloud-based servers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

1. A network device for managing network segmentation of a network infrastructure, the network device comprising:
at least one processor; and
at least one memory including computer program code, the at least one memory and the computer program code configured to, with the at least one processor, cause the network device to
receive a request to execute a distributed workload, the request including distributed workload information, the distributed workload information including an objective function, and the objective function including at least one of a function for minimizing a number of reconfigurable resources used, a function for minimizing a total energy consumption of the reconfigurable resources, or a function for minimizing a link bandwidth usage,
compute a network configuration for the network infrastructure by
computing a network segmentation configuration based on the distributed workload information, the objective function, and a current status of the network infrastructure, and
computing an ad-hoc network configuration based on the network segmentation configuration, and
configure a plurality of reconfigurable resources of a programmable device to execute the distributed workload based on the network configuration.

2. (canceled)

3. The network device of claim 1, wherein the at least one memory and the computer program code are further configured to, with the at least one processor, cause the network device to:
compute the ad-hoc network configuration by allocating the plurality of reconfigurable resources according to a respective bandwidth capacity of a reconfigurable resource of the plurality of reconfigurable resources and a respective computed bandwidth of the reconfigurable resource.

4. The network device of claim 1, wherein the at least one memory and the computer program code are further configured to, with the at least one processor, cause the network device to compute the ad-hoc network configuration by at least one of:
defining reconfigurable partitions of the reconfigurable resources; or
defining a static logic of the reconfigurable resources.

5. The network device according to claim 1, wherein the at least one memory and the computer program code are further configured to, with the at least one processor, cause the network device to:
compute the network segmentation configuration based on the distributed workload information, the current status of the network infrastructure, topological and functional properties of the plurality of reconfigurable resources and a given reconfiguration time.

6. The network device of claim 1, wherein the at least one memory and the computer program code are further configured to, with the at least one processor, cause the network device to:
determine the current status of the network infrastructure based on physical properties of the network infrastructure.

7. (canceled)

8. The network device of claim 1, further comprising:
a memory storing a library of allocation algorithms; and wherein
the at least one memory and the computer program code are further configured to, with the at least one processor, cause the network device to
determine an allocation algorithm, from the library of allocation algorithms, based on the request, and
compute the network segmentation configuration based on the distributed workload information and the current status of the network infrastructure according to the allocation algorithm,
wherein the allocation algorithm is a polynomial time complexity algorithm.

9. The network device of claim 1, further comprising:
a memory storing a library of programming protocol-independent processor (P4) switches; and wherein
the at least one memory and the computer program code are further configured to, with the at least one processor, cause the network device to
configure the plurality of reconfigurable resources based on P4 switches of the library of P4 switches.

10. A method for managing network segmentation of a network infrastructure, the method comprising:
receiving a request to execute a distributed workload from a network orchestrator, the request including distributed workload information, the distributed workload information including an objective function, and the objective function including at least one of a function for minimizing a number of reconfigurable resources used, a function for minimizing a total energy consumption of the reconfigurable resources, or a function for minimizing a link bandwidth usage;
computing a network configuration for the network infrastructure by
computing a network segmentation configuration based on the distributed workload information, the objective function, and a current status of the network infrastructure, and
computing an ad-hoc network configuration based on the network segmentation configuration; and
configuring a plurality of reconfigurable resources of a programmable device to execute the distributed workload based on the network configuration.

11. (canceled)

12. The method of claim 10, wherein the computing the ad-hoc network comprises:
allocating the plurality of reconfigurable resources according to a respective bandwidth capacity of a reconfigurable resource of the plurality of reconfigurable resources and a respective computed bandwidth of the reconfigurable resource.

13. The method of claim 10, wherein the computing the ad-hoc network configuration includes at least one of:
defining reconfigurable partitions of the reconfigurable resources; or
defining static logic of the reconfigurable resources.

14. The method of claim 10, further comprising:
determining the current status of the network infrastructure based on physical properties of the network infrastructure.

15. (canceled)

16. The method of claim 10, further comprising:
determining an allocation algorithm, from a library of allocation algorithms, based on the request; and
computing the network segmentation configuration based on the distributed workload information and the current status of the network infrastructure according to the allocation algorithm,
wherein the allocation algorithm is a polynomial time complexity algorithm.

17. A non-transitory computer-readable storage medium storing computer-readable instructions that, when executed, cause one or more processors at a network device to perform a method for managing network segmentation of a network infrastructure, the method comprising:
receiving a request to execute a distributed workload from a network orchestrator, the request including distributed workload information, the distributed workload information including an objective function, and the objective function including at least one of a function for minimizing a number of reconfigurable resources used, a function for minimizing a total energy consumption of the reconfigurable resources, or a function for minimizing a link bandwidth usage;
computing a network configuration for the network infrastructure by
computing a network segmentation configuration based on the distributed workload information, the objective function, and a current status of the network infrastructure, and
computing an ad-hoc network configuration based on the network segmentation configuration; and
configuring a plurality of reconfigurable resources of a programmable device to execute the distributed workload based on the network configuration.

18. (canceled)

19. The non-transitory computer-readable storage medium of claim 17, wherein the computing the ad-hoc network comprises:
allocating the plurality of reconfigurable resources according to a respective bandwidth capacity of a reconfigurable resource of the plurality of reconfigurable resources and a respective computed bandwidth of the reconfigurable resource.

20. The non-transitory computer-readable storage medium of claim 17, wherein the computing the ad-hoc network configuration includes at least one of:
defining reconfigurable partitions of the reconfigurable resources; or
defining static logic of the reconfigurable resources.
